(19) United States
(12) Patent Application Publication
(10) Pub. No.: US 2004/0230811 A1
(43) Pub. Date: Nov. 18, 2004

(54) Authentication system and method allowing for selection of a location to perform various authentication operations

(75) Inventors: William G. Siegel, Wellington, FL (US); Gregory L. Cannon, Boynton Beach, FL (US)

Correspondence Address: STERNE, KESSLER, GOLDSTEIN & FOX PLLC, 1100 NEW YORK AVENUE, N.W., WASHINGTON, DC, 20005, US

(73) Assignee: Cross Match Technologies, Inc.

(21) Appl. No.: 10/843,566

(22) Filed: May 12, 2004

Related U.S. Application Data
(60) Provisional application No. 60/470,846, filed on May 16, 2003.

(51) Int. Cl. H04L 9/00

(52) U.S. Cl. 713/186

(57) ABSTRACT

System and methods for authenticating biometric data (e.g., fingerprint data, or the like) have an automatic location selection operation (i.e., a failsafe operation) or a manual location selection operation (i.e., a selectivity operation). These two operations ensure an authentication operation can always quickly and accurately take place. The automatic location selection operation is based on having main system including a local and remote authentication system. If a network link to the remote authentication system is broken, the main system detects that and switches authentication to a local authentication system. The manual location selection operation allows an operator to select, through an input device (e.g., buttons or a switch), whether to perform authentication operations locally or remotely. Even in this manual location selection mode, if remote authentication is selection, but a network link to the remote system is broken, the main system switches to local authentication. Thus, an authentication operation will always be available, timely, and accurate.

### CROSS REFERENCE TO RELATED APPLICATION

This application claims benefit under 35 U.S.C. 119(e) to U.S.

Provisional Patent Application 60/470,846, filed May 16, 2003, entitled “Authentication System And Method Allowing For Selection Of A Location To Perform Various Authentication Operations,” which is incorporated by reference herein in its entirety.

### BACKGROUND OF THE INVENTION

1. Field of the Invention

The present invention is directed to the field of access control and remote identity verification, in particular, utilizing biometric technology.

2. Background Art

Access control systems are used to limit access to selected individuals. Some of these systems use biometric technologies to determine whether access for an individual will be granted or denied. A biometric is a unique, measurable characteristic or trait of a human being for automatically recognizing or verifying identity. For instance, fingerprint biometrics are largely regarded as an accurate method of biometric identification and verification. See, e.g., Roethenbaugh, G. Ed., Biometrics Explained (International Computer Security Association: Carlisle, Pa. 1998), pages 1-34. Access control units (ACUs) may be placed locally to perform a biometric analysis on the individual, and determine whether access will be granted or denied. One drawback of some existing systems is that they rely on a predetermined network link configuration for a remote authentication system. Hence, if the network link is broken, no authentication can take place. This becomes a problem in environments with lines for admittance or where instant and immediate authentication is required.

Therefore, what is needed is a system and method for authentication that has the ability to automatically select a location for authentication and also has the ability to manually select the location for authentication so that authentication is always available, timely, and accurate.

### BRIEF SUMMARY OF THE INVENTION

Embodiments of the present invention provide a system for resilient authentication of biometric information including a biometric capture device that captures biometric information from a person, a local authentication system that authenticates the biometric information and outputs a matching result signal, and a remote authentication system that authenticates the biometric information and outputs a matching result signal. The system also includes a controller that determines which of one of the local or remote authentication systems is coupled to the biometric capture device.

Other embodiments of the present invention provide a system for resilient authentication of biometric information including a first device and a second device. The first device includes a biometric capture device, a first authentication system, a controller coupled to the capture device and the first authentication system, an input device coupled to the controller, and an output device coupled to the controller. The second device includes a second authentication device. The controller activates an authentication operation in either the first or second device.

Still other embodiments of the present invention provide method including the steps of capturing biometric information and controlling transmission of said biometric information to a first or second location. The method also includes the steps of extracting biometric data from said biometric information at one of the first or second location and matching said biometric data to stored biometric data at a same one of the first or second location where said extracting occurred. The method further includes the steps of generating a result signal based on said matching and outputting a signal based on said result signal.

An advantage of the above systems and methods is that they are resilient if a link between a capture device and a remote authentication system is broken a local authentication system can still timely and accurately complete an authentication operation. Alternatively, if a local authentication system is down, a remote authentication system can still timely and accurately complete an authentication operation.

Another advantage of the above systems and methods a user has the ability to determine whether to perform an authentication procedure locally or remotely.

Further embodiments, features, and advantages of the present inventions, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a block diagram showing an exemplary authentication system according to embodiments of the present invention.

FIG. 2 is a flowchart depicting a method for capturing biometric data and for determining whether a remote link is active according to embodiments of the present invention.

FIG. 3 is a flowchart depicting a method for allowing manual location selection according to embodiments of the present invention.

FIG. 4 is a flowchart depicting a method for local authentication according to embodiments of the present invention.

FIG. 5 is a flowchart depicting a method for remote authentication according to embodiments of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

Overview

Embodiments of the present invention provide systems and methods for authenticating biometric data (e.g., fingerprint data, or the like) have an automatic location selection operation (i.e., a failsafe operation) or a manual location selection operation (i.e., a selectivity operation). These two operations ensure an authentication operation can always quickly and accurately take place. The automatic location selection operation is based on having a main system including a local and remote authentication system. If a network link to the remote authentication system is broken, the main system detects that and switches authentication to a local authentication system. The manual location selection operation allows an operator to select, through an input device (e.g., buttons or a switch), whether to perform authentication operations locally or remotely. Even in this manual location selection mode, if remote authentication is selected, but a network link to the remote system is broken, the main system switches to local authentication. Thus, an authentication operation will always be available, timely, and accurate.

The use of the term “data” or “information” throughout the specification can be data representative of a biometric, a digital or other image of a biometric (e.g., a bitmap or other file), extracted digital or other information relating to the biometric, minutia detail, etc.

An object or biometric as used throughout the specification may be a physical part of an individual, such as an eye, a finger, a limb, etc. An accessed system as used through the specification may be any known system that requires some limitation to entry, which can be a computer, electrical or mechanical equipment, a room, a hallway, a building, a section of a compound, etc. Matching used throughout the specification relates to matching either 1:1 to determine if the individual matches with whom he/she says he/she is or 1:m, where m=all the enrollees, to determine if an individual is an enrollee at all.

Access Control System

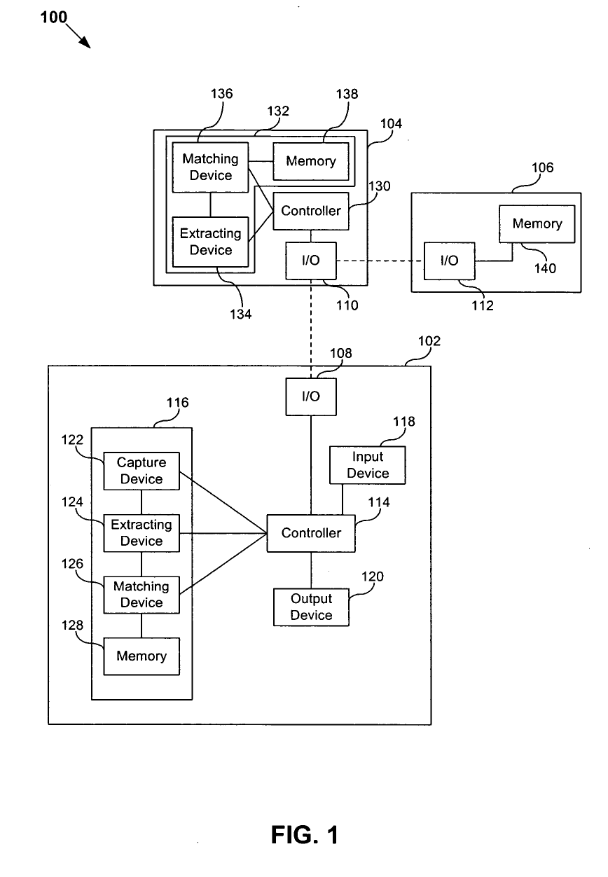

FIG. 1 is a block diagram showing a system 100 according to embodiments of the present invention. System 100 can be a biometric (e.g., fingerprint, etc.) authentication system used for access control to places (e.g., buildings, stadiums, complexes, rooms, hallways, etc.) or things (e.g., computers, machines, etc.). System 100 includes a first device 102 and a second device 104. In some embodiments, system 100 can also include a third device 106. The devices 102, 104, and 106 can be coupled via a wired or wireless network, as depicted by dashed lines. The devices 102, 104, and 106 are coupled to the wired or wireless network by appropriate input/output (I/O) devices 108, 110, and 112, respectively. I/O devices 108, 110, and 112 can be any know I/O device, such as USB, Ethernet, or the like. One or more of the devices 102, 103, and 106 can be scanners available from Cross Match Technologies, Inc.

First or device 102 includes a controller 114 that controls all signals and data flowing through first device 102. Controller 114 is coupled to a first or “local” (i.e., located in or near first device 102) biometric authentication system 116, an input device 118, an output device 120, and I/O device 108. Local biometric authentication section includes a capture device (e.g., a live biometric reading device) 122, an extracting device 124, and a matching device 126 coupled to a memory 128. In various embodiments, first or device 102 can be a handheld unit, a tabletop unit, a wall-mounted unit, or any other type of or device used in authentication systems. Also, in various embodiments, first or device 102 can be maintained by an entity trying to restrict access or a different entity (e.g., a third party vendor or a governmental agency hired to monitor access to a place or thing).

Second device 104 can include a controller 130 that controls signals and data flowing through second device 104. In some embodiments, controller 114 can also control second or device 104. In those embodiments, controller 130 would not be needed. Controller 130 is coupled to a second or “remote” (i.e., located outside first or device 102) biometric authentication system 132. Remote biometric authentication system 132 includes an extracting device 134 and a matching device 136 coupled to a memory 138. In various embodiments, second or device 104 can be maintained by an entity maintaining first or device 102 or by a different entity (e.g., a third party vendor or governmental agency).

In embodiments where a lot of memory is needed that cannot be housed in second or device 104 (or in some cases first or device 102), a third or device 106 can be included in the system. Third or device 106 includes a memory 140 with a relatively large storage capacity. Second or device 104 via I/O devices 110 and 112 accesses memory 140.

Input device 118 can be any device that allows a selection to be made between local or remote authentication. For example, a switch can be moved to a state indicating local or remote authentication choice. As another example, a mechanical or electrical command device (e.g., a button, or the like) can be activated to indicate a local or remote authentication choice. It is also to be appreciated that even in remote authentication mode, a broken remote device network link can be sensed. If this occurs, system 100 can automatically switch to a local authentication state.

Output device 120 can be a one dimensional (e.g., light emitting diode(s) (LED(s)) display or a two dimensional (e.g., textual or graphical) display. If two-dimensional, any type of display (e.g., liquid crystal, plasma, LEDs, etc.) can be used. The output can indicate that authentication was successful or unsuccessful, or any other indication desired by the operator.

Automatic and Manual Location Selection Operations

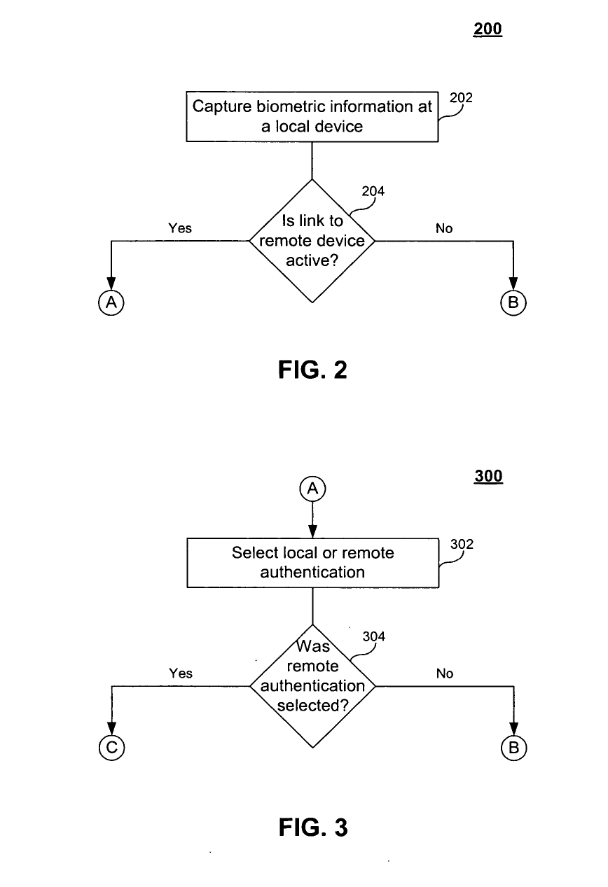

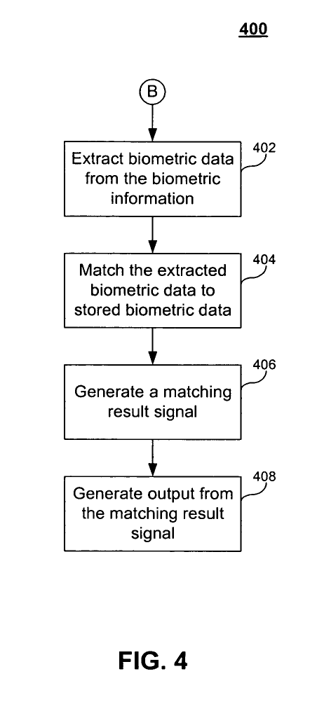

FIG. 2 is a flowchart depicting a method 200 for beginning an authentication operation according to embodiments of the present invention. At step 202, a local device captures biometric information. At step 204, a determination is made whether a link to a remote device is active. If no, method 400 (FIG. 4) described below is performed. If yes, either method 300 (FIG. 3) is performed (e.g., if a manual location selection operation is occurring) or method 500 (e.g., if a remote location selection operation is occurring) is performed.

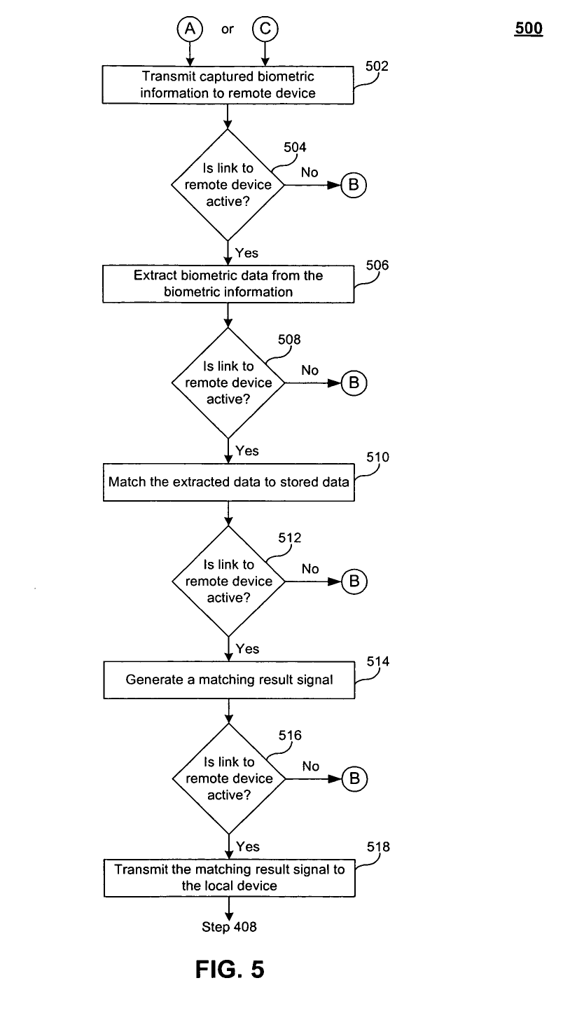

FIG. 3 is a flowchart depicting method 300 for a manual location selection operation according to embodiments of the present invention. Again, if step 204 is yes, at step 302 a selection is made whether to perform local or remote authentication. At step 304, a determination is made whether remote authentication was selected. If yes, method 500 (FIG. 5) is performed. If no, method 400 (FIG. 4) is performed.

FIG. 4 is a flowchart depicting method 400 for local authentication according to embodiments of the present invention. Again, if at step 204 no remote link is active or at step 304 no remote authentication was selected, then step 402 is performed. At step 402, biometric data is extracted from the captured biometric information. At step 404, the extracted biometric data is matched to stored biometric data. At step 406, a matching result signal is generated, which can represent whether the matching was successful or unsuccessful. At step 408, an output is generated based on the matching result signal. The output can indicate authentication or failure to authenticate either visually or audibly.

FIG. 5 is a flowchart depicting method 500 for remote authentication according to embodiments of the present invention. Again, if at step 204 a remote link is active and at step 304 a remote authentication is selected, the step 502 is performed. At step 502, a copy of the captured biometric information is transmitted to the remote device. At step 504, a determination is made whether the remote link is still active. If no, method 400 is performed. If yes, at step 506 biometric data is extracted from the biometric information. At step 508, a determination is made whether the remote link is still active. If no, method 400 is performed. If yes, at step 510 the extracted biometric data is matched to stored biometric data. The stored biometric data can be at the remote device or accessed from another remote device. This can be based on how much biometric data is stored or how large a pool of potential matches an operator wishes to draw from. At step 512, a determination is made whether the remote link is still active. If no, method 400 is performed. If yes, at step 514 a matching signal is generated, which can represent whether the matching was successful or unsuccessful. At step 516, a determination is made whether the remote link is still active. If no, method 400 is performed. If yes, at step 518 the matching result signal is transmitted to the local device. Once the local device receives the matching result signal, step 408 is performed.

It is to be appreciated that the methods and systems above can be implemented in hardware, software, firmware, and/or a combination of all.

Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A system for resilient authentication of biometric information, the system comprising:
a biometric capture device that captures the biometric information from a person;
a local authentication system that authenticates the biometric information and outputs a matching result signal;
a remote authentication system that authenticates the biometric information and outputs a matching result signal; and
controller that determines which of one of said local or remote authentication systems is coupled to said biometric capture device.

2. The system of claim 1, wherein said local authentication system comprises:
an extractor that extracts biometric data from the biometric information; and
a matching device coupled said extractor that matching the biometric data to data stored in a memory device coupled to the matching device, wherein said matching device also generates the matching result signal.

3. The system of claim 1, wherein said remote authentication system comprises:
an extractor that extracts biometric data from the biometric information; and
a matching device coupled said extractor that matching the biometric data to data stored in a memory device coupled to the matching device, wherein said matching device also generates the matching result signal.

4. The system of claim 1, further comprising a that holds said biometric capture device, said local authentication system, said output device, and said controller.

5. The system of claim 1, further comprising:
first that holds said biometric capture device, said controller, and said output device; and
a second that holds said remote authentication system.

6. The system of claim 5, wherein a memory associated with said remote authentication system is located in said second housing.

7. The system of claim 5, wherein a memory associated with said remote authentication system is located in a third housing.

8. The system of claim 5, further comprising another controller located in said second that controls the remote authentication system.

9. The system of claim 5, wherein said first comprises a first input/output (I/O) device and said second comprises a second I/O device and said biometric information is transferred via a network between said first and second housings.

10. The system of claim 9, wherein said network is a wireless network.

11. The system of claim 9, wherein said network is a wired network.

12. The system of claim 9, wherein said first and second I/O devices are USB devices.

13. The system of claim 9, wherein said first and second I/O devices are Ethernet devices.

14. The system of claim 1, further comprising:
an input device that is coupled to said controller, wherein said controller bases the determination on an input signal from said input device.

15. The system of claim 14, wherein said input device comprises:
a first button corresponding to said local authentication device; and
a second button corresponding to said remote authentication device.

16. The system of claim 14, wherein said input device comprises a switch that can be position in a first state corresponding to said local authentication device or a second state corresponding to said remote authentication device.

17. The system of claim 1, further comprising:
an I/O device coupled to said controller, wherein said controller bases the determination on whether or not a signal is being received from said I/O device.

18. The system of claim 1, wherein said output device comprises a set of light emitting diodes (LEDs).

19. The system of claim 1, wherein said output device comprises an auditory signal device.

20. The system of claim 1, wherein said output device comprises a textual display device.

21. The system of claim 1, wherein said output device comprises a graphical display device.

22. The system of claim 1, further comprising:
a handheld device that includes said biometric capture device, said local authentication system, said controller, and said output device; and
a remote device coupled to said handheld device, said remote device including said remote authentication system.

23. The system of claim 1, further comprising:
a table-top device coupled to a machine that controls access to said machine, said table-top device including said biometric capture device, said local authentication device, said controller, and said output device; and
a remote device coupled to said tabletop device, said remote device including said remote authentication system.

24. The system of claim 1, further comprising:
a wall mounted device coupled to a machine that controls access to said machine, said wall mounted device including said biometric capture device, said local authentication system, said controller, and said output device; and
a remote coupled to said wall-mounted device, said remote including said remote authentication system.

25. A system comprising:
a first device including,
a capture device,
a first authentication system,
a controller coupled to said capture device and said first authentication system,
an input device coupled to said controller, and
an output device coupled to said controller; and
a second device including a second authentication device;
said controller activating an authentication operation in either the first or second device based on being coupled to said input device.

26. The system of claim 25, wherein said first authentication system comprises:
an extractor coupled to said capture device;
a matching device coupled to said extractor; and
a memory coupled to said matching device.

27. The system of claim 25, wherein said second authentication system comprises:
an extractor coupled to said capture device;
a matching device coupled to said extractor; and
a memory coupled to said matching device.

28. The system of claim 25, wherein said second device further comprises a controller that controls said second authentication device.

29. The system of claim 25, wherein said input device comprises:
a first button corresponding to said first device; and
a second button corresponding to said second device;
wherein said controller activates one of said first and second devices based on which of said first and second button is selected by a user.

30. The system of claim 25, wherein said input device comprises a switch that can be position in a first state corresponding to said first authentication device or a second state corresponding to said second authentication device.

31. The system of claim 25, wherein said input device is an I/O device in said first device that is coupled to an I/O device in said second device and wherein said controller activates one of said first and second devices based whether or not a signal is received from said I/O device in said second device at said I/O device in said first device.

32. The system of claim 25, wherein said first device is a handheld device.

33. The system of claim 25, wherein said first device is a tabletop device.

34. The system of claim 25, wherein said first device is a wall-mounted device.

35. A method comprising the steps of:
capturing biometric information;
controlling transmission of said biometric information to a first or second location;
extracting biometric data from said biometric information at one of the first or second location;
matching said biometric data to stored biometric data at a same one of the first or second location where said extracting occurred;
generating a result signal based on said matching; and
outputting a signal based on said result signal.

36. The method of claim 35, further comprising the step of sensing a control signal, wherein said controlling step bases a selection of the first and second location for said extracting, said matching, and said generating steps on said sensing step.

37. The method of claim 35, wherein said sensing step is performed at the first location and said control signal is based on a user selecting one of the first or second locations.

38. The method of claim 35, wherein said sensing step is performed at the first location and said control signal is based on whether or not a link signal is received at the first location from the second location.

39. The method of claim 35, further comprising storing the stored biometric data at a same one of said first and second locations as said matching step occurs.

40. The method of claim 35, further comprising storing the stored biometric data at a different one of said first and second locations as said matching step occurs.

41. The method of claim 35, further comprising storing the stored biometric data a third location.

42. The method of claim 35, wherein the first location is a local location and the second location is a remote location.

43. The system of claims 1, further comprising:
an output device that provides an output based on receiving an appropriate one of the matching result signals
